(19) United States
(12) Patent Application Publication
(10) Pub. No.: US 2015/0201543 A1
(43) Pub. Date: Jul. 23, 2015

(54) ROTOR DEVICE

(71) Applicant: AHWI Maschinenbau GmbH, Herdwangen (DE)

(72) Inventor: Artur WILLIBALD, Uberlingen (DE)

(21) Appl. No.: 14/600,141

(22) Filed: Jan. 20, 2015

(30) Foreign Application Priority Data
Jan. 21, 2014 (DE) 10 2014 100 612.7

(51) Int. Cl. A01B 33/10; A01B 39/08; A01B 33/02

(52) U.S. Cl. CPC A01B 33/103; A01B 33/02; A01B 39/085

(57) ABSTRACT

The invention is based on a rotor device with at least one rotor that is supported rotatably about a rotor axis, and with a drive unit which is provided for driving the at least one rotor and which comprises at least one drive shaft with at least one section that extends, in at least one operating position of the at least one rotor, at least substantially parallel with respect to the rotor axis. It is proposed that the rotor device comprises a compensation unit which is provided to permit a change of an orientation of the rotor axis with respect to the at least one section.

### STATE OF THE ART

The invention relates to a rotor device according to the preamble of claim 1. From DE 10 2011 117 770 A1 a vehicle device is known, with a power source and with a drive unit which is firmly connected to the power source. The drive unit comprises an output shaft for driving an insert tool which can be oriented with respect to the drive unit. A rotary axis of the output shaft is oriented perpendicularly with respect to a forward direction of the vehicle device and thus parallel with respect to a rotor axis of a comminution rotor.

The objective of the invention is in particular to provide a generic rotor device with advantageous characteristics regarding a compensation of ground unevenness. The objective is achieved by the features of patent claim 1, while advantageous embodiments and further developments of the invention may be gathered from the subclaims.

### ADVANTAGES OF THE INVENTION

The invention is based on a rotor device with at least one rotor that is supported rotatably about a rotor axis, and with a drive unit which is provided for driving the at least one rotor and which comprises at least one drive shaft with at least one section that extends, in at least one operating position of the at least one rotor, at least substantially parallel with respect to the rotor axis.

It is proposed that the rotor device comprises a compensation unit, which is provided to permit a change of an orientation of the rotor axis with respect to the at least one section. A “rotor device” is to mean, in particular, a working device for a work vehicle, which working device is in particular provided to be mounted, in a permanent and/or a temporary manner, in particular to an undercarriage of the work vehicle. The at least one rotor device may be any work device that is deemed expedient by the person skilled in the art, preferably however a mulcher, a ground cultivator, a wood milling machine, a wood comminutor, a snowblower and/or a demining machine. The work vehicle may in particular be a vehicle for ground machining and/or snow machining and/or for biomass comminuting and/or biomass harvesting, preferably a wood milling vehicle, a ground cultivating vehicle, a snowblower vehicle, a mulching vehicle and/or a demining vehicle. A “rotor” is to be understood, in this context, in particular as a work unit which is drivable via the drive unit and is provided for ground processing and/or vegetation processing, in particular for milling and/or comminuting and/or dethatching and/or clearing. “Provided” is to mean, in particular, specifically designed and/or equipped. By an object being provided for a certain function, it is in particular to be understood that the object fulfills and/or implements this certain function in at least one application state and/or operating state. In particular the at least one rotor is embodied as a rotational body, at which tool elements, in particular cutting elements and/or chains, are arranged. A “rotor axis” is to be understood, in this context, in particular as an axis intersecting the at least one rotor. The rotor axis is in particular a rotary symmetry axis of a smallest geometric cylinder which just completely encompasses the at least one rotor. Preferentially the at least one rotor carries out complete rotations around the rotor axis during an operation of the rotor device, a rotational speed being in particular at least 500 rpm.

A “drive unit” is to be understood, in this context, in particular as a unit which is provided to supply the at least one rotor with kinetic energy via the at least one drive shaft. Preferably the drive unit comprises a mechanical and especially advantageously a form-fit gear unit. Preferably the drive unit comprises a transfer gear unit and is, especially advantageously, implemented as a transfer gear unit. Furthermore the drive unit can additionally comprise a power source, in particular a motor, preferably a diesel engine, an electromotor and/or a hybrid motor. A “transfer gear unit” is to be understood, in this context, in particular as a gear unit which transfers an input torque introduced via an input shaft to at least one drive shaft which is arranged at an angle with respect to the input shaft. Arranged “at an angle” is to mean, in particular, at an angle of more than 0° and less than 180°. Preferably the input shaft and the at least one drive shaft are arranged at least substantially perpendicularly with respect to each other. “At least substantially perpendicularly” with respect to a reference direction is to mean, in particular, at an angle that differs by maximally 10°, in particular by maximally 5°, preferably by maximally 2° and especially advantageously by maximally 1° from a right angle with respect to the reference direction. A “section” of the drive shaft is to mean, in this context, in particular a portion of the drive shaft, which preferably starts out of the drive unit from an exit point, which portion has an at least substantially constant extension direction over its entire longitudinal extension. “At least substantially parallel” with respect to a reference direction is to mean in particular at an angle of no more than 5°, preferably no more than 3° and especially advantageously maximally 1° with respect to the reference direction.

By the compensation unit being provided to “permit a change of an orientation of the rotor axis with respect to the at least one section” it is to be understood, in particular, that the compensation unit permits at least an in particular parallel shifting of the rotor axis with respect to the at least one section and/or at least a tilting of the rotor axis with respect to the at least one section in particular about at least one tilt axis preferably extending at least substantially perpendicularly with respect to the at least one section. The change of the orientation of the rotor axis with respect to the at least one section can be effected actively or, in particular due to external influences, passively. In particular the compensation unit comprises at least one first compensation element, the position of which is variable in particular with respect to the at least one section, and/or the position of which with respect to the rotor axis is at least substantially invariable. In particular the compensation unit comprises at least one second compensation element, which at least partially takes in the at least one first compensation element and/or at least defines a direction along which a position of the one first compensation element is variable in particular with respect to the at least one section. In particular the at least one second compensation element can be pivotable about the at least one section, wherein a distance between the at least one section and the at least one second compensation element can be at least substantially invariable.

By way of such an implementation a generic rotor device with improved characteristics regarding a compensation of unevenness of ground, in particular during a running operation of the rotor device, can be provided. As a result of this an advantageously effective operation of the rotor device is possible and/or damages to the rotor device and/or to a suspension of the rotor device, in particular due to unevenness of ground, can be at least largely avoided.

In a preferred embodiment of the invention it is proposed that the at least one drive shaft is implemented at least partially as a universal shaft, preferably at least partially as a Cardan shaft. Preferably the at least one drive shaft comprises at least two joints, which are provided to allow a direction deflection of the driveshaft, in particular during an operation of the at least one rotor device. The drive shaft further comprises at least one partial section that is in particular variable in length in the manner of a telescope. It can thus be advantageously ensured that a force transfer from the at least one drive shaft to the at least one rotor can be effected at least substantially without an influence of an orientation of the rotor axis with respect to the at least one section.

It is moreover proposed that an orientation and/or a position of the at least one rotor is variable with respect to a ground plane. A “ground plane” is to be understood, in this context, in particular as an at least substantially horizontal plane on which a work vehicle stands which comprises the rotor device, wherein in particular drive wheels and/or caterpillar tracks of the work vehicle contact the ground plane in particular with at least one tread and/or a support surface. An orientation and/or a position of the at least one rotor being “variable” with respect to the ground plane is to mean, in this context, in particular that a distance between the at least one rotor and the ground plane can be increased and/or reduced and/or the rotor is tiltable with respect to the ground plane, in particular about at least one tilt axis extending in particular substantially perpendicularly with respect to the at least one section. As a result of this an advantageous adaptation of the rotor device to in particular changing ground conditions can be achieved.

Furthermore it is proposed that the drive unit comprises at least one power source, the position and/or orientation of which is at least substantially fix with respect to the at least one section. A “power source” is to mean, in particular, a unit which is provided to convert chemical energy and/or electrical energy and/or thermal energy into kinetic energy, in particular rotational energy. The at least one power source can herein be embodied in particular as a motor, in particular as a combustion engine, preferably as a diesel engine, and/or as an electromotor and/or as a hybrid motor. Position and/or orientation of a first unit being “at least substantially fix” with respect to a second unit is to mean, in particular, that in at least one assembled state, in particular apart from vibrations during an operating state of the rotor device and/or from a clearance, a distance of the two units from each other and an angular orientation of the units with respect to each other remain constant. Preferentially a maximum relative variation of the distance of the two units from each other in at least one assembled state is always maximally 10%, in particular maximally 5%, preferably no more than 1% and especially advantageously no more than 0.1%. Preferably a maximum variation of an angle between any area normal of the first unit and any area normal of the second unit in at least one assembled state is always maximally 20°, in particular maximally 10°, preferably no more than 5° and especially advantageously no more than 1°. Thus an advantageously reliable and/or interference-insensitive force transfer from the at least one power source to the at least one section is achievable.

In a further preferred implementation of the invention it is proposed that the compensation unit comprises at least one slotted link and at least one conducting element which is supported movably along the at least one slotted link. Preferably the compensation unit comprises at least two guiding elements which are in particular oriented such that they are aligned with each other. The at least one guiding element is advantageously implemented as a bolt having in particular an at least substantially circle-shaped cross section. A “slotted link” is to be understood, in this context, in particular as a guiding unit, in which the at least one conducting element at least partially engages in an assembled state and along which the at least one conducting element can in particular glide. Preferentially the at least one slotted link comprises at least two guiding elements extending at least substantially parallel with respect to each other, which in particular delimit a receiving region for the at least one conducting element in at least two directions. Preferably the at least one slotted link is implemented as a long hole and/or as a groove. A distance between the at least two guiding elements corresponds at least substantially to an outside diameter of the at least one conducting element and is preferably slightly greater than the outside diameter. In an assembled state, the at least one conducting element is slidable along the at least two guiding elements. Thus a change of the orientation of the rotor axis with respect to the at least one section may be permitted in an advantageously simple manner.

In an especially preferred embodiment of the invention it is proposed that at least one motion direction of the at least one conducting element extends along the at least one slotted link at least substantially perpendicularly with respect to the rotor axis. As a result of this, an advantageously simple and/or reliable change of an orientation and/or of a position of the at least one rotor with respect to a ground plane may be allowed.

It is further proposed that the rotor device comprises a pivot unit, which is provided to pivot the at least one rotor with respect to the drive unit about a pivot axis, which in particular differs from the rotor axis. A “pivot axis” is to mean, in particular, a rotary axis about which the at least one rotor is pivoted during a pivoting procedure with respect to the drive unit, in particular as an entity. Preferentially the pivot unit comprises a pivot bearing by which the pivot axis is defined. Preferably the pivot unit additionally comprises at least one force unit, in particular a hydraulic-cylinder unit, for generating a force to the purpose of pivoting the insert tool. Thereby advantageously a height adjustment of the insert tool may be allowed.

Furthermore it is proposed that the at least one section and the pivot axis extend at least substantially parallel with respect to each other in the at least one operating position. Preferably a center-point distance of the at least one section from the pivot axis is maximally 10 cm, in particular no more than 5 cm, preferentially maximally 2 cm and especially advantageously maximally 1 cm in the at least one operating position. Preferably the at least one section and the pivot axis are at least partially superposable in the at least one operating position. As a result of this an advantageous pivoting of the at least one rotor may be allowed with respect to the drive unit. In particular an advantageously robust pivot unit can be provided. Further in particular a construction length of a pivot unit is advantageously reduceable.

It is moreover proposed that the rotor device comprises a pull element drive unit, which is provided to transfer at least one torque from the at least one drive shaft to the at least one rotor. A “pull element drive unit” is to be understood, in particular, as a transmission unit wherein a torque is transferred between two shafts by means of a pull element that is looped around both shafts. Preferably the pull element drive unit is implemented as a force-fit pull element drive unit. Thereby a reliable force flow from the at least one drive shaft to the at least one rotor can be generated. Preferentially the rotor unit comprises at least two pull element drive units, which are in particular connected in parallel, as a result of which a force transfer can be optimized. In particular a force occurring maximally in the pull element can be reduced, whereby in particular a service life of the pull element can be advantageously increased.

### DRAWINGS

Further advantages may be gathered from the following description of the drawings. In the drawings an exemplary embodiment of the invention is shown. The drawings, the description and the claims contain a plurality of features in combination. The person skilled in the art will purposefully also consider the features separately and will arrange them in further expedient combinations.

It is shown in

FIG. 1 a work vehicle with a rotor device with a rotor in a work position in a lateral view,

FIG. 2 the work vehicle with the rotor device with the rotor in a topmost end situation in a lateral view,

FIG. 3 a portion of the rotor device with a drive unit, a pull element drive unit, a compensation unit and the rotor, in an isometric overview presentation,

FIG. 4 a portion of the rotor device with a pivot unit and the compensation unit, in another isometric overview presentation, and

FIG. 5 a portion of the rotor device with the compensation unit in a lateral view.

### Description of the exemplary embodiment

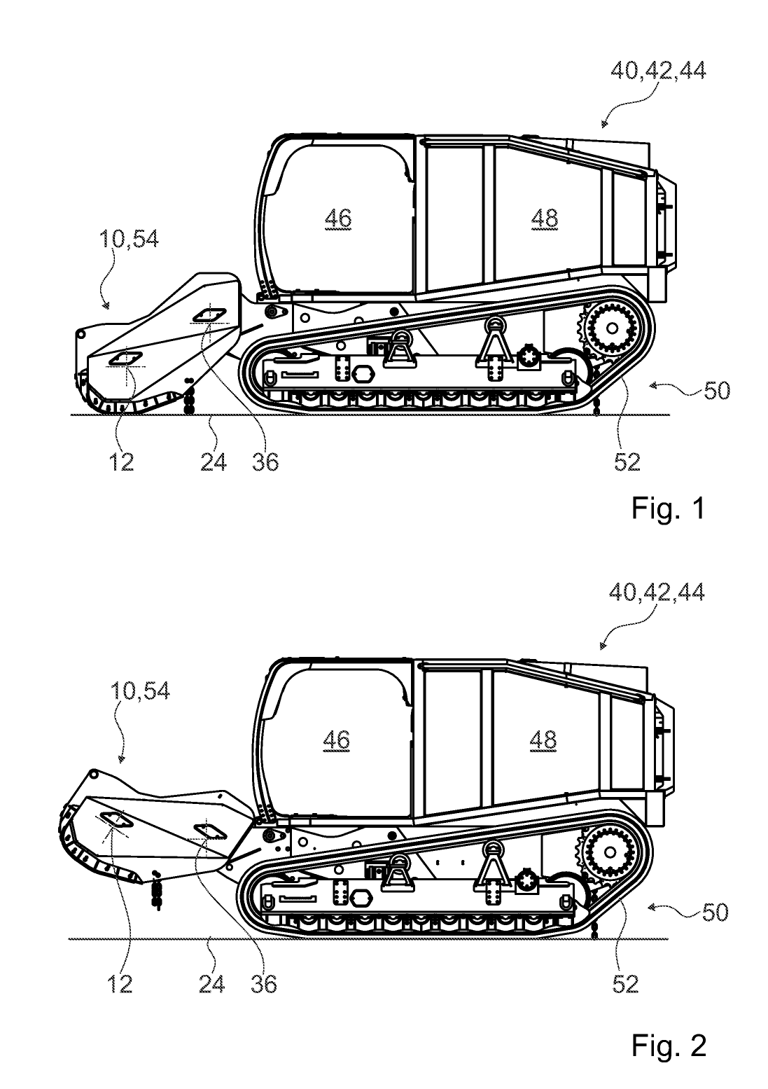

FIGS. 1 and 2 show a work vehicle 40 implemented as a mulching vehicle 42 in a lateral view. The work vehicle 40 is implemented as a caterpillar tractor 44. The work vehicle 40 comprises a driver's cab 46, an engine space 48 and an undercarriage 50. The work vehicle 40 can be controlled by a driver from the driver's cab 46. The undercarriage 50 comprises caterpillar tracks 52, which improve a forward thrust of the work vehicle 40, in particular also in difficult terrain. A rotor device 10 with a rotor 14 that is rotatably supported about a rotor axis 12 is mounted at the work vehicle 40. The rotor device 10 is embodied as a mulcher 54. A position of the rotor 14 is variable with respect to a ground plane 24 of the work vehicle 40, in particular the rotor 14 can be lifted and/or lowered. FIG. 1 shows the rotor device 10 in a work position. In the work position a bottom edge of the rotor device 10 is situated at the level of the ground plane 24. FIG. 2 shows the rotor device 10 in a topmost end position with a maximum height of the rotor 14 above the ground plane 24 of the undercarriage 50. In the topmost end position the rotor axis 12 is located approximately 1900 mm above the ground plane 24. It is also possible to bring the rotor device 10 into a bottom most end situation, which is not depicted. In the bottom most end situation, a bottom edge of the rotor device 10 is situated approximately 350 mm below the ground plane 24.

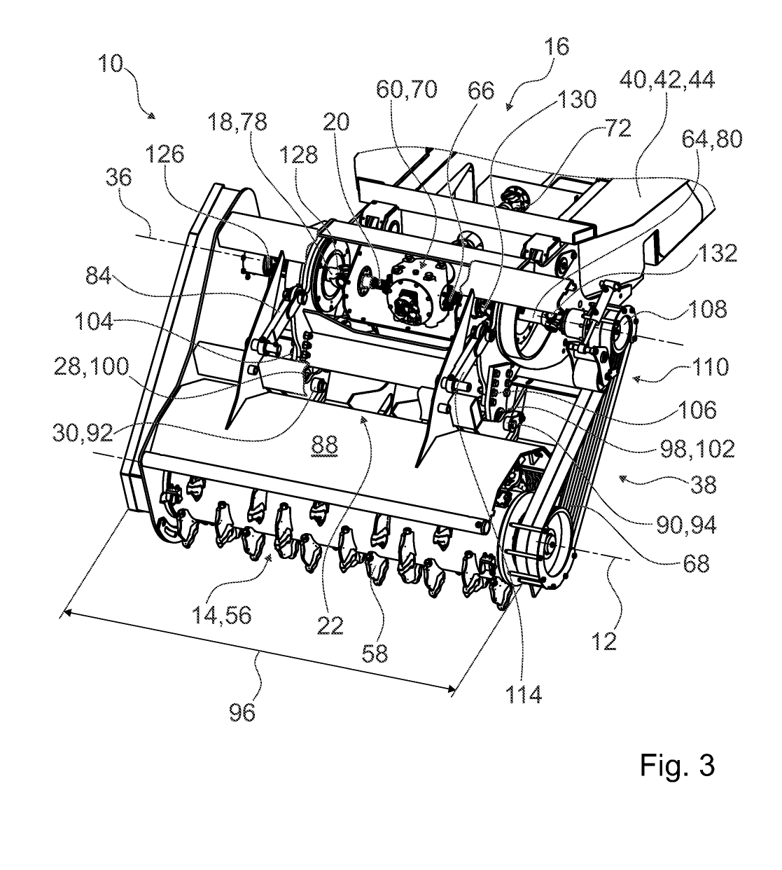

FIG. 3 shows a portion of the rotor device 10 in an isometric overview presentation. The rotor device 10 comprises a drive unit 16, which comprises a gear unit 60 as well as a power source, which is here only depicted schematically, and the rotor 14. The rotor 14 is implemented as a cutting rotor 56 that is known from the pertinent prior art. Such a cutting rotor 56 is known, e.g., from DE 43 27 120 C1. In an operating state the cutting rotor 56 rotates about the rotor axis 12, wherein biomass, like in particular twigs and branches, is comminuted by cutting tools 58 that are arranged at an open-cylinder shaped surface of the cutting rotor 56. The rotor device 10 further comprises, to both sides of the cutting rotor 56, respectively one pull element drive unit 38, only one of which is visible, for driving the cutting rotor 56. The pull element drive units 38 are implemented as belt drive units 62. Via the pull element drive units 38, the cutting rotor 56 is driven by two drive shafts 18, 64. Each pull element drive unit 38 comprises a pull element tensioning unit 110, which is provided, in a known manner, for tensioning the pull element 68 of the respective pull element drive unit 38. The gear unit 60 is implemented as an angular drive unit 70 comprising an input shaft 72 and the two drive shafts 18, 64. The drive shafts 18, 64 are embodied as universal shafts 78, 80. The drive shafts 18, 64 each comprise a respective section 20, 66 which, in the operating position shown, extends parallel with respect to the rotor axis 12. The sections 20, 66 are arranged in a straight-line extension with respect to each other and perpendicularly with respect to the input shaft 72. The drive shafts 18, 64 are provided for driving the rotor 14 of the rotor device 10. The input shaft 72 is oriented in parallel to a forward direction 74 of the work vehicle 40 in an assembled state. The input shaft 72 is driven, in an operating state, by the power source. The gear unit 60 is fixedly connected to the power source, as a result of which a position and an orientation of the power source with respect to the sections 20, 66 of the drive shafts 18, 64 is fix. The power source is preferably embodied as a combustion engine. The power source is preferentially arranged in the engine space 48 of the work vehicle 40 and can, in particular, be fastened at a frame of the work vehicle.

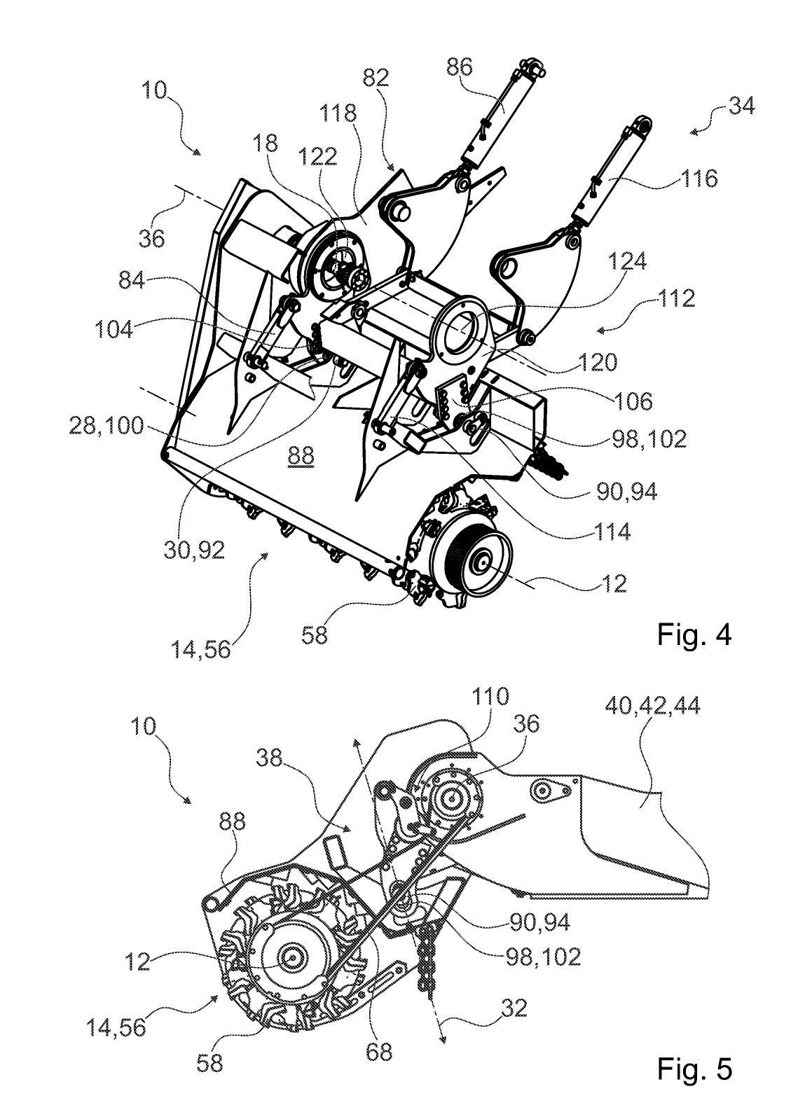

FIG. 4 shows a portion of the rotor device 10 in a further isometric presentation. A pivot unit 34 is provided to pivot the rotor 14 with respect to the drive unit 16 about a pivot axis 36. The pivot axis 36 extends, in the operating position depicted, in parallel with respect to the sections 20, 66 of the drive shafts 18, 64 (cf. FIG. 3). The sections 20, 66 of the drive shafts 18, 64 and the pivot axis 36 extend, in the operation position depicted, at least substantially such that they are superposable (cf. FIG. 3). In dependence of the operating position, a position and/or an orientation of a pivot axis may vary with respect to sections of a drive shaft. The pivot unit 34 comprises two pivot arms 82, 112, which are arranged parallel with respect to each other. The pivot arms 82, 112 are operated hydraulically in a manner known. The pivot arms 82, 112 each comprise a pivot element 118, 120, which respectively comprises a circle-shaped recess 122, 124, through which a respective one of the drive shafts 18, 64 is guided. The pivot unit 34 further comprises two mechanical thrust and/or pull elements 84, 114 arranged parallel with respect to each other, each of which is respectively fastened, on the one hand, to the pivot elements 118, 120 of the pivot arms 82, 112 and, on the other hand, to an upper region of a rotor housing 88, in which the rotor 14 is supported. The thrust and/or pull elements 84, 114 serve to transfer pivot motion of the pivot elements 118, 120 of the pivot arms 82, 112 caused by hydraulic cylinders 86, 116 to the rotor housing 88, and to thus induce a pivoting of the rotor 14 about the pivot axis 36.

The rotor device 10 further comprises a compensation unit 22, which permits a change of an orientation of the rotor axis 12 with respect to the sections 20, 66 of the drive shafts 18, 64. The compensation unit 22 comprises two conducting elements 30, 90. The conducting elements 30, 90 are implemented as bolts 92, 94 with a circle-shaped cross section. The conducting elements 30, 90 are firmly connected to the rotor housing 88. The conducting elements 30, 90 are respectively arranged in an exterior third of the rotor housing 88 with respect to a longitudinal extension 96 of the rotor housing 88. The conducting elements 30, 90 extend parallel with respect to the rotor axis 12 and are oriented aligned with each other. The compensation unit 22 further comprises two slotted links 28, 98. The slotted links 28, 98 are implemented as long holes 100, 102. This can be seen in particular in FIG. 5, which shows a portion of the rotor device 10 in a lateral view. The slotted links 28, 98 have been introduced into a construction element 104, 106 which is, for example, fixedly connected to the pivot elements 118, 120 of the pivot arms 82, 112 by means of screwing and/or welding. As an alternative, slotted links can also be introduced directly into pivot arms and/or pivot elements. The conducting elements 30, 90 are respectively guided through the slotted links 28, 98 and are movable along the slotted links 28, 98. A motion direction 32 of the conducting elements 30, 90 along the slotted links 28, 98 extends perpendicularly with respect to the rotor axis 12 (cf. FIG. 5). The compensation unit 22 makes it possible that during an operation of the rotor devices 10 in particular unevenness of a ground to be machined can be compensated. If during an operation of the rotor device 10 an unevenness is driven over with the rotor 14, the rotor 14 is lifted by this unevenness. Herein the liberty of motion of the conducting elements 30, 90 along the slotted links 28, 98 allows a change of the position of the rotor axis 12 with respect to the sections 20, 66 of the drive shafts 18, 64 and/or allows a tilting of the rotor axis 12 with respect to the sections 20, 66 of the drive shafts 18, 64. In particular shearing forces can thus be prevented from occurring, which could result in damage to the rotor device 10. A change of the orientation of the rotor axis 12 with respect to the sections 20, 66 of the drive shafts 18, 64 results in an offset between the sections 20, 66 of the drive shafts 18, 64 and drive wheels 108 (only one of which is visible) of the pull element drive units 38, which are driven by the drive shafts 18, 64. This offset is compensated by respectively two Cardan joints of the drive shafts 18, 64, which connect the drive unit 60 to the drive wheels 108 (cf. FIG. 3).

1. A rotor device with at least one rotor that is supported rotatably about a rotor axis, and with a drive unit which is provided for driving the at least one rotor and which comprises at least one drive shaft with at least one section that extends, in at least one operating position of the at least one rotor, at least substantially parallel with respect to the rotor axis, wherein a compensation unit is provided to permit a change of an orientation of the rotor axis with respect to the at least one section.

2. The rotor device according to claim 1, wherein the at least one drive shaft is at least partially embodied as a universal shaft.

3. The rotor device according to claim 1, wherein an orientation and/or a position of the at least one rotor is variable with respect to a ground plane.

4. The rotor device according to claim 1, wherein the drive unit comprises at least one power source, a position and/or orientation of which is at least substantially fix with respect to the at least one section.

5. The rotor device according to claim 1, wherein the compensation unit comprises at least one slotted link and at least one conducting element, which is supported movably along the at least one slotted link.

6. The rotor device according to claim 5, wherein at least one motion direction of the at least one conducting element extends along the at least one slotted link at least substantially perpendicularly with respect to the rotor axis.

7. The rotor device according to claim 1, wherein a pivot unit is provided to pivot the at least one rotor with respect to the drive unit about a pivot axis.

8. The rotor device according to claim 7, wherein the at least one section and the pivot axis extend at least substantially parallel with respect to each other in the at least one operating position.

9. The rotor device according to claim 1, wherein a pull element drive unit is provided to transfer at least one torque from the at least one drive shaft to the at least one rotor.

10. A work vehicle, in particular a mulching cultivator and/or a forestry cultivator, with at least one rotor device according to claim 1.

11. The rotor device according to claim 2, wherein an orientation and/or a position of the at least one rotor is variable with respect to a ground plane.

12. The rotor device according to claim 2, wherein the drive unit comprises at least one power source, a position and/or orientation of which is at least substantially fix with respect to the at least one section.

13. The rotor device according to claim 2, wherein the compensation unit comprises at least one slotted link and at least one conducting element, which is supported movably along the at least one slotted link.

14. The rotor device according to claim 2, wherein a pivot unit is provided to pivot the at least one rotor with respect to the drive unit about a pivot axis.

15. The rotor device according to claim 2, wherein a pull element drive unit is provided to transfer at least one torque from the at least one drive shaft to the at least one rotor.

16. A work vehicle, in particular a mulching cultivator and/or a forestry cultivator, with at least one rotor device according to claim 2.

17. The rotor device according to claim 3, wherein the drive unit comprises at least one power source, a position and/or orientation of which is at least substantially fix with respect to the at least one section.

18. The rotor device according to claim 3, wherein the compensation unit comprises at least one slotted link and at least one conducting element, which is supported movably along the at least one slotted link.

19. The rotor device according to claim 3, wherein a pivot unit is provided to pivot the at least one rotor with respect to the drive unit about a pivot axis.

20. The rotor device according to claim 3, wherein a pull element drive unit is provided to transfer at least one torque from the at least one drive shaft to the at least one rotor.
